(19) United States
(12) Patent Application Publication
(10) Pub. No.: US 2007/0050456 A1
(43) Pub. Date: Mar. 1, 2007

(54) Automated creation of e-mail distribution lists

(76) Inventors: John Vuong, San Jose, CA (US); Sarah Korah, San Jose, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/216,641

(22) Filed: Aug. 30, 2005

(51) Int. Cl. G06F 15/16

(52) U.S. Cl. 709/206

(57) ABSTRACT

A system and method enhance the performance of e-mail distribution list related functionality. A software application facilitates the automatic creation and/or modification of e-mail distribution lists. An e-mail distribution list may be automatically created or modified before or after the e-mail is sent, or after the e-mail is received. The software application may automatically create and/or modify a distribution list using all of the recipient e-addresses or one or more selected recipient e-addresses located in an addressee field of an e-mail, such as the “to” and/or “cc” fields. The automatic creation and/or modification of a distribution list may be accessed via an icon, button, drop down menu, or other input means. The software application may automatically create and/or modify the title of the e-mail distribution list. Additionally, the software application may automatically create and/or modify contact information associated with the e-mail distribution list.

### BACKGROUND

The present embodiments relate generally to electronic mail. More particularly, a software application assists a user with functions related to e-mail distribution lists.

The Internet and other networks, such as intranets, have increased the use of communication via e-mail (electronic mail). A typical e-mail includes a short textual message sent between friends, co-workers, colleagues, or peers. An e-mail sender may send an e-mail to a number of e-addresses (electronic addresses), each e-address being a text string representing the address of a personal e-mail account, an Internet address, or other virtual or electronic address. Each e-address selected as a recipient of the e-mail may be manually selected from a list of e-addresses and subsequently displayed in an addressee field of the e-mail, such as the “to” or “cc” field.

The sender may desire to create a new e-mail distribution list containing the recipient e-addresses displayed in one or more addressee fields of the e-mail. Likewise, a recipient of the e-mail may desire to create an e-mail distribution list that includes the recipient e-addresses. An e-mail user manually selects each e-address desired to be added to a new e-mail distribution list from a lengthy list of e-addresses when creating the distribution list. The manual selection of e-addresses during the creation of the distribution list may require the performance of tedious and time consuming input operations. Additionally, the manual selection of e-addresses may result in an unwanted e-address being erroneously added to or not included in the distribution list.

### BRIEF SUMMARY

By way of introduction, the embodiments described below include methods, processes, apparatuses, instructions, or systems for employing a software application that automatically creates and/or modifies an e-mail distribution list. The software application may automatically create and/or modify an e-mail distribution list using the e-addresses displayed in an addressee field of the e-mail, such as the “to” or “cc” field. The software application also may automatically create and/or modify a title for the distribution list. Additionally, the software application may automatically create and/or modify contact information associated with the distribution list.

In a first aspect, a data processing system performs functionality related to an e-mail distribution list. The system includes a display screen operable to display an e-mail having an addressee field that includes an e-address. The system also includes a processing unit operable to create an e-mail distribution list from the e-address located in the addressee field.

In a second aspect, a data processing system performs functionality related to an e-mail distribution list. The system includes a display screen operable to display an e-mail having an addressee field that includes an e-address. The system also includes a processing unit operable to modify an e-mail distribution list using the e-address located in the addressee field.

In a third aspect, a method performs functionality related to an e-mail distribution list. The method includes displaying an e-mail on a display screen that includes an e-address located within an addressee field. The method also includes creating an e-mail distribution list from the e-address.

In a fourth aspect, a computer-readable medium having instructions executable on a computer and stored thereon is described. The instructions include generating e-mail having an e-address within an addressee field. The instructions also include creating, modifying, or creating and modifying an e-mail distribution list using the e-address located in the addressee field.

The present invention is defined by the following claims. Nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The present invention will become more fully understood from the detailed description given herein below and the accompanying drawings which are given by way of illustration only, and are not limitative of the present invention, and wherein:

FIG. 1 is a flowchart of an exemplary method for automatically creating and/or automatically modifying an e-mail distribution list;

FIG. 2 is an exemplary e-mail;

FIGS. 3, 4, and 5 illustrate an exemplary e-mail user interface operable to automatically perform functionality related to an e-mail distribution list;

FIGS. 6 and 7 illustrate another exemplary e-mail user interface operable to automatically perform functionality related to an e-mail distribution list;

FIGS. 8 and 9 illustrate another exemplary e-mail user interface operable to automatically perform functionality related to an e-mail distribution list;

FIG. 10 is a block diagram of an exemplary data processing system; and

FIG. 11 illustrates a flowchart of another method for automatically creating and/or automatically modifying an e-mail distribution list.

### DETAILED DESCRIPTION OF THE DRAWINGS AND PRESENTLY PREFERRED EMBODIMENTS

A software application provides e-mail (electronic mail) related functionality. The software application employs a user interface. The user interface facilitates the automatic creation and/or automatic modification of an e-mail distribution list. The e-mail distribution list includes one or more e-addresses (electronic addresses), each e-address may be an individual or personal e-mail address, website address, or other electronic address. For instance, the software application may automatically create and/or modify an e-mail distribution list using the recipient e-addresses in the “to” field, “cc” field, and/or other addressee field of an e-mail. The software application also may automatically create and/or automatically modify the title of the e-mail distribution list or contact information associated with the e-mail distribution list.

In general, the software application allows a user to send and receive e-mail. After completing the selection of the recipient e-addresses to which an e-mail is to be delivered, a user may desire to automatically create and/or automatically modify an e-mail distribution list using one or more of the recipient e-addresses selected. The automatic creation of an e-mail distribution list may include creating an entirely new distribution list from scratch or involve the modification of an existing distribution list to create a new modified distribution list.

The user may automatically create and/or modify an e-mail distribution list before the e-mail is sent. Alternatively, an already sent e-mail may be retrieved, such as from a “sent e-mail box.” Subsequently, an e-mail distribution list may be automatically created and/or modified using one or more of the recipient e-addresses to which the e-mail was addressed. Additionally, after the receipt of an e-mail, an e-mail distribution list may be automatically created and/or modified by a recipient of the e-mail using one or more of the recipient e-addresses.

The software application may automatically create an e-mail distribution list that includes all of the e-addresses to which an e-mail is addressed, or all of the e-addresses in the “to” field, the “cc” field, the “bcc” field, or any other addressee field, or any combination of addressee fields to which an e-mail is addressed. Alternatively, the user may individually select one or more e-addresses from one or more e-addressee fields, such as the “to” and “cc” fields, and the software application may subsequently automatically create an e-mail distribution list that includes the selected e-addresses.

The software application may automatically create a title for a new e-mail distribution list or automatically modify the title of an existing e-mail distribution list. For instance, the software application may use the subject line of the e-mail or one of the recipient e-addresses to automatically create or modify a title. The software application may search for one or more key words in the subject line of the e-mail or in the recipient e-address to be included in the title. Alternate manners of creating or modifying a distribution list title may be used.

The software application may automatically create and/or automatically modify contact information associated with an e-mail distribution list. For each e-address in the distribution list, an individual's first and last name, the individual's employer or place of business, or other contact information may be determined.

I. Exemplary Automatic E-Mail Distribution List Actions

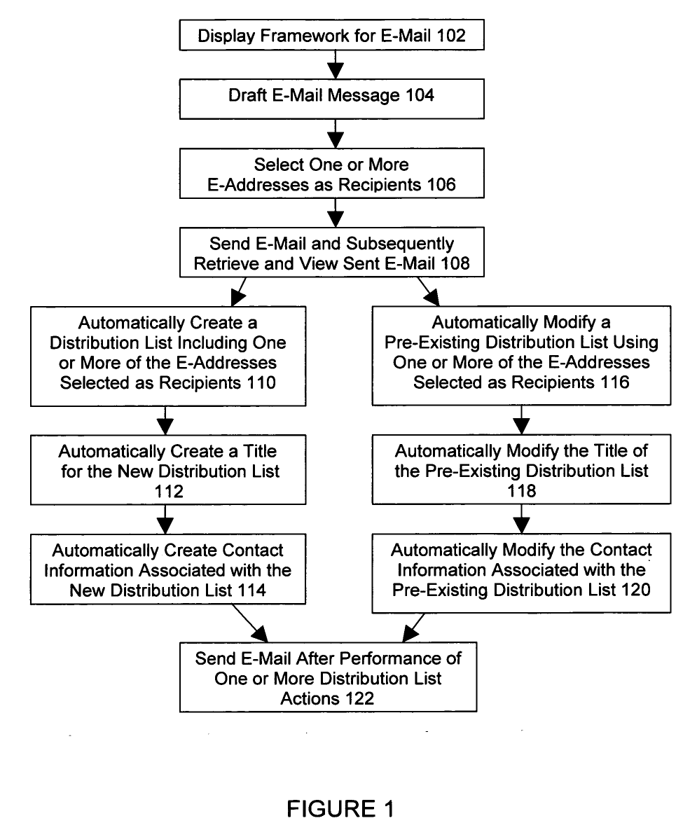

FIG. 1 is a flowchart of an exemplary method for automatically creating and/or automatically modifying an e-mail distribution list. The method may include displaying a framework for an e-mail 102, drafting an e-mail message 104, selecting one or more e-addresses as recipients 106, sending the e-mail and subsequently viewing the e-mail sent 108, automatically creating an e-mail distribution list 110, automatically creating a title for the distribution list 112, automatically creating contact information for the distribution list 114, automatically modifying an e-mail distribution list 116, automatically modifying the title of the distribution list 118, automatically modifying the contact information for the distribution list 120, and/or sending the e-mail after the performance of one or more distribution list actions 122. The method may include additional, fewer, or alternate actions.

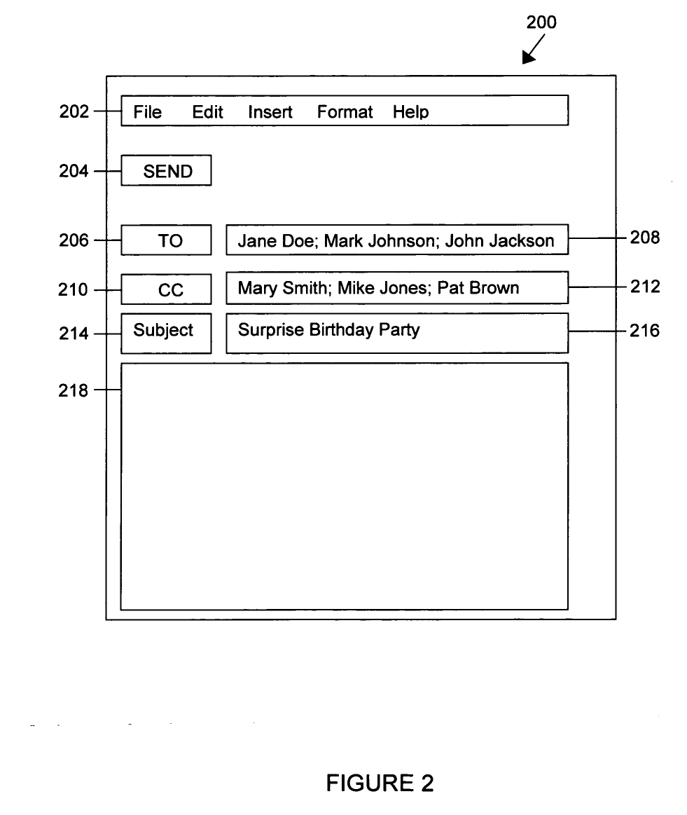

The method may include displaying the framework for an e-mail 102. FIG. 2 illustrates an exemplary e-mail 200. The e-mail 200 may include a command bar 202, a “send” button 204, a “to” button 206, a “to” field 208, a “cc” button 210, a “cc” field 212, a subject header 214, a subject line 216, and a message box 218. The e-mail 200 may include additional, fewer, or alternate components.

After the framework for an e-mail is displayed 102, a user may draft an e-mail message 104. The e-mail message may be displayed in the message box 218 during and after drafting. The e-mail message may be drafted by an input device, such as typed on a keyboard or recorded via a voice recognition device and subsequently displayed. Other manners may be used to draft an e-mail message. Alternatively, a new e-mail message may not have to be drafted in the case of an e-mail intended to forward a previous e-mail, file, website address, or other information to one or more e-addresses.

One or more recipient e-addresses may be selected as recipients of the e-mail 106. If a new e-mail message is to be drafted 104, the e-addresses may be selected 106 either before or after the e-mail message is drafted 104. The “to” and “cc” buttons 206, 210 may each be an icon, button, component of a menu or bar, or other graphic. An operation performed on the “to” or “cc” button 206, 210 may facilitate the selection of recipient e-addresses for the “to” or “cc” field, respectively. For instance, the recipient e-addresses of the e-mail 200 may be selected from a list of e-addresses or the e-addresses may be typed. Alternate manners of selecting recipient e-addresses may be used.

After the e-mail message has been drafted 104 and the recipients selected 106, the user may send the e-mail to the recipients and subsequently retrieve and view the sent e-mail 108, including the recipient e-addresses. In the example of FIG. 2, the send button 204 may be used to send the e-mail to one or more recipients via a network. The send button 204 may be an icon, button, component of a menu, component of the command bar 202, or other input graphic. The send functionality associated with the send button 204 may be accessed by an input device. Alternate manners of sending the e-mail may be used.

After the e-mail is sent, a user may retrieve the e-mail from a folder or electronic “box” of sent e-mail. The e-mail, including the e-addresses in the “to” field 208, “cc” field 212, and/or other addressee fields, such as a “bcc” field, may be viewed on a display screen. The software application may then automatically perform one or more distribution list actions 110, 112, 114, 116, 118, and 120. Alternatively, instead of sending an e-mail and subsequently retrieving the sent e-mail 108 before automatically performing one or more distribution list actions 110, 112, 114, 116, 118, and 120, the e-mail may be sent after the automatic performance of one or more distribution list actions 122.

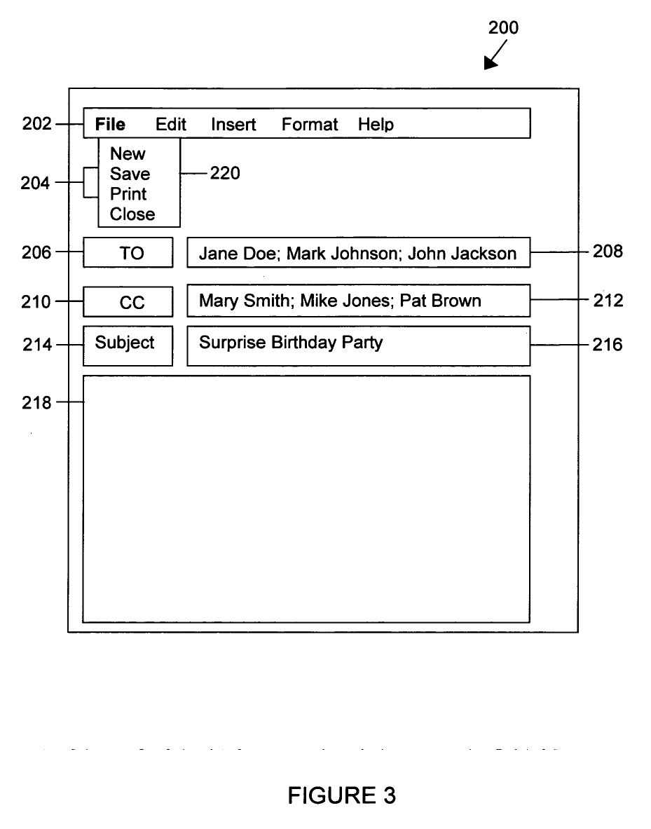

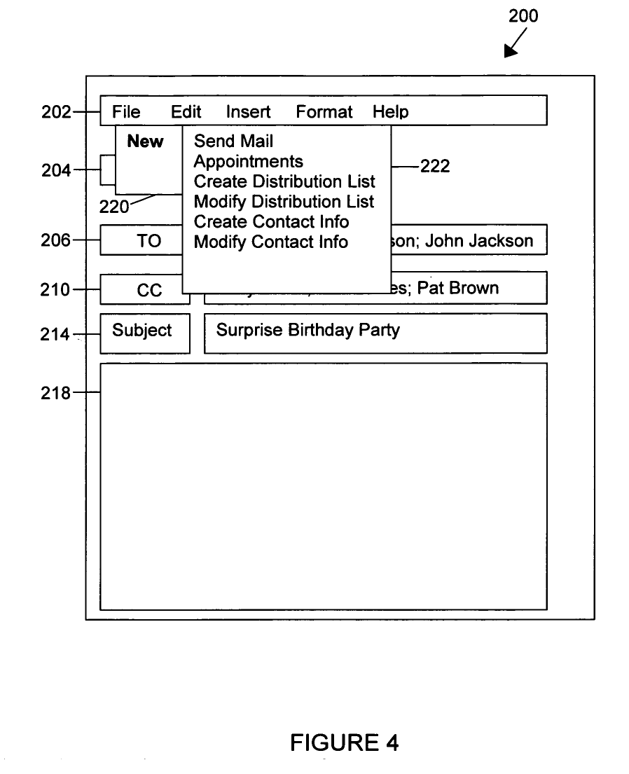

After one or more e-addresses are selected 106, the method may include automatically creating and/or automatically modifying a distribution list including one or more of the selected e-addresses 110, 116. FIGS. 3 and 4 together illustrate an exemplary e-mail user interface operable to automatically create and/or automatically modify an e-mail distribution list.

The command bar 202 may provide access to a number of e-mail related functions. The command bar 202 may include typical “file,” “edit,” “insert,” “format,” and “help” buttons that provide access to corresponding functionality. Each button in the command bar 202 may have an associated drop down menu that may be accessed by moving a cursor over the button, clicking on the button, or other operation performed on the button. Each drop down menu may provide access to one or more functional options associated with the button. The command bar 202 may have additional, fewer, or alternate buttons and corresponding functionality.

In the example of FIG. 3, the file button has an associated first drop down menu 220 that provides access to e-mail related functionality, such as sending a new e-mail, saving the e-mail, printing the e-mail, or closing the drop down menu via the corresponding “new,” “save,” “print,” and “close” buttons. Additional, fewer, or alternate buttons and corresponding functionality may be provided by the first drop down menu.

FIG. 4 illustrates that the “new” button may provide access to a second drop down menu 222. The second drop down menu 222 may be accessed by moving a cursor over the “new” button in the first drop down menu 220, by clicking on the “new” button via an input device, such as a mouse, or by performing another operation on the “new” button. The second drop down menu 222 may provide access to further e-mail functionality. For instance, the second drop down menu 222 may include functionality related to sending e-mail, appointments, distribution lists, and/or contact lists. Each function may have a corresponding button in the second drop down menu 222.

II. Automatic Creation of E-Mail Distribution Lists

The example shown in FIG. 4 illustrates the second drop down menu 222 may include “create distribution list,” “modify distribution list,” “create contact info,” and/or “modify contact info” buttons. Each button may provide access to related e-mail distribution list functionality as discussed herein. The second drop down menu 222 may provide additional, fewer, or alternate buttons and corresponding functionality.

After a user has selected one or more recipient e-addresses for an e-mail, such as shown in the example of FIG. 4, the “create distribution list” button may automatically create a new distribution list including one or more of the e-addresses selected as recipients 110. The new distribution list automatically created by the software application may include all of the e-addresses selected as recipients, such as “Jane Doe,” “Mark Johnson,” “John Jackson,” “Mary Smith,” “Mike Jones,” and “Pat Brown” in FIGS. 3 and 4.

Alternatively, the distribution list automatically created may include only the e-addresses selected as recipients within a specific e-mail addressee field, such as the “to” field 208 (“Jane Doe,” “Mark Johnson,” and “John Jackson” in FIGS. 3 and 4), the “cc” field 210 (“Mary Smith,” “Mike Jones,” and “Pat Brown” in FIGS. 3 and 4), a “bcc” field, or any combination of addressee fields (such as both the “to” and “cc” fields). Other groupings of recipient e-addresses may be used to automatically create a new distribution list.

The automatic creation of an e-mail distribution list from one or more recipient e-addresses of an e-mail, either before or after the e-mail is sent, may alleviate the need to manually create the e-mail distribution list. For instance, the automatic creation of the e-mail distribution list may eliminate the individual selection via an input device of every e-address in the distribution list from a separate global or lengthy list of e-addresses that includes numerous e-addresses un-related to the e-mail 200. Manually selecting e-addresses from a separate list of e-addresses un-related to the e-mail 200 to create the distribution list may become tedious or lead to the erroneous selection of one or more e-addresses.

A title for a new e-mail distribution list may be automatically created 112. As shown in the example of FIG. 4, the e-mail 200 may include a subject header 214 that identifies the location of the subject line 216. The subject line 216 may identify the subject matter to which the e-mail 200 pertains. The software application may automatically name the new distribution list using all or part of the subject line 216 information.

For example, if the subject line 216 is relatively short, the title may include the entire subject line 216, such as “Surprise Birthday Party” in the example of FIG. 4. However, if the subject line 216 is rather long, the title may include a few words automatically selected from the subject line 216, such as the first few words or one or more key words in the subject line 216. The software application may identify one or more of the longer words in the subject line 216 as key words. Alternatively, a list of common sayings may be stored in a memory. The software application may compare the contents of the subject line 216 with the common sayings. If there is an approximate or identical match, the common saying or the corresponding words in the subject line 216 may be identified as key words. In the example shown, the software application may automatically recognize the term “birthday party” as a common saying and automatically name the distribution list as “Birthday Party.”

Other methods and algorithms may be used to automatically name the distribution list. For instance, the e-address of one or more recipients, the first recipient e-address, contact information related to the recipients, the date, or a simple numerical counting method (such as list one, list two, etc. or Birthday Party 1, Birthday Party 2, etc.) may be used to automatically name the distribution list. Manual naming may be provided.

After the distribution list has been named, the software application may automatically add the title of the distribution list to one or more lists of e-addresses, such as a global list of e-addresses, a limited list of e-addresses, a list of e-addresses directed to a specific category (such as businesses, individuals, customers, suppliers, distributors, etc.), a list of e-mail distribution lists, or other type of e-address lists. Subsequently, when a user is determining the recipient(s) of a subsequent e-mail, the title of the distribution list may be viewed in the list of e-addresses, such as in the form of a button or icon. An operation performed on the title or title button via an input device may add the distribution list to the recipient addresses of the subsequent e-mail.

Contact information associated with a new distribution list may be automatically created 114. The second drop down menu 222 may include a “create contact info” button that provides access to functionality that automatically creates contact information for the new distribution list. Alternatively, the contact information for the new distribution list may be automatically created during the creation of the new distribution list. For instance, the contact information for the new distribution list may be automatically created by an operation performed on the “create distribution list” button that also results in the creation of the distribution list.

The software application may parse each e-address in the new distribution list associated with an individual to create corresponding contact information. For the example shown, Jane Doe may have a work-related e-address of jane.doe@company. The software application may recognize from Jane Doe's e-address that Jane's first name is Jane, second name is Doe, and that Jane's employer is Company. The software application may access a database of telephone numbers or search the Internet or another network to determine if Jane has any accessible telephone numbers (such as a home, cell, or work-related telephone numbers), other e-addresses (such as personal or work-related e-addresses), home street address, or other available contact information. The software application may access a database or search the Internet or another network to determine the telephone number, street address, e-address, or other available contact information for Company. The software application may perform additional, fewer, or alternate searches.

III. Automatic Modification of E-Mail Distribution Lists

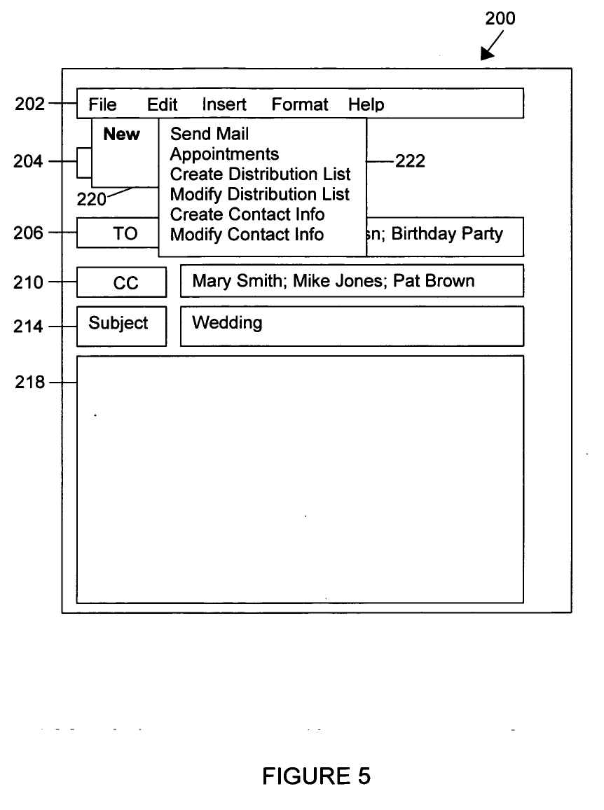

One of the recipient e-addresses or the sender of an e-mail may include an existing e-mail distribution list, such as the “Birthday Party” distribution list shown in the example of FIG. 5. The existing distribution list may be automatically modified by adding, removing, or replacing one or more of the other recipient e-addresses located in an addressee field of the e-mail.

After a user has selected one or more recipient e-addresses for an e-mail, the “modify distribution list” button may automatically modify an existing distribution list, such as the “Birthday Party” distribution list in FIG. 5, that is also selected as a recipient e-address. Other distribution lists may be automatically modified, such as a distribution list selected from a list of distribution lists or other e-address list. The distribution list may be automatically modified using all of the recipient e-addresses or only one or more recipient e-addresses selected.

In the example of FIG. 5, the “Birthday Party” distribution list may be automatically modified by using all of the other e-addresses selected as recipients, such as “Jane Doe,” “Mark Johnson,” “Mary Smith,” “Mike Jones,” and “Pat Brown.” Alternatively, the distribution list may be automatically modified using only the e-addresses selected as recipients within a specific e-mail addressee field, such as the “to” field 208 (“Jane Doe” and “Mark Johnson” in FIG. 5), the “cc” field 210 (“Mary Smith,” “Mike Jones,” and “Pat Brown” in FIG. 5), a “bcc” field, or any combination of addressee fields, such as both the “to” and “cc” fields. Other groupings of recipient e-addresses may be used to automatically modify the distribution list.

A user may want to have one or more recipient e-addresses of an e-mail automatically added to the distribution list if those e-addresses are not currently part of the distribution list, such as in the case of a user wanting to add an e-address of a new colleague, co-worker, or friend to a frequently used distribution list. However, a user may not recall if an e-address is currently part of the distribution list.

The software application may automatically verify whether the recipient e-addresses are currently part of the distribution list. If a recipient e-address is not currently part of the distribution of list, the software application may automatically add that recipient e-address to the distribution list. On the other hand, if the recipient e-address is already a member of the distribution of list, the software application may automatically ensure that the recipient e-address only receives the e-mail once, and not twice if the e-mail is subsequently sent to both the individual e-address and the distribution list to which the e-address belongs. In one embodiment, the “modify distribution list” button may provide access to functionality that automatically modifies the existing distribution list by adding all of the recipient e-addresses, or those selected, to the distribution list if the recipient e-addresses are not currently part of the distribution list.

The software application may automatically remove one or more recipient e-addresses from a distribution list if the recipient e-addresses are currently part of the distribution list. For instance, it may no longer be necessary for a colleague, co-worker, or friend to remain on a distribution list. The software application may automatically verify whether each individual recipient e-address is currently part of the distribution list. If a recipient e-address is currently part of the distribution of list, the software application may automatically remove that recipient e-address from the distribution list.

In one embodiment, the “modify distribution list” button may provide access to functionality that automatically modifies the existing distribution list by removing from the distribution list all of the individual recipient e-addresses that are currently part of the distribution list. Alternatively, the user may individually select one or more of the individual recipient e-addresses to be removed from the distribution list if the selected recipient e-addresses are currently part of the distribution list.

The software application may automatically replace one or more outdated or secondary e-addresses in the distribution list, such as in the case of a recipient getting a new e-address. The software application may automatically search for a “match” between all of the individual recipient e-addresses, or only those selected, and the e-addresses currently in the distribution list. The software application may compare an individual recipient e-address with each e-address, or a portion thereof, in the distribution list. Alternatively, the software application may compare the contact information for each individual recipient e-address with the corresponding contact information of each e-address in the distribution list.

If a match is determined to exist, the individual recipient e-address may be identified as an updated recipient e-address and the corresponding previous e-address may be identified as an outdated e-address. The software application may automatically replace the outdated e-address in the distribution list with the updated recipient e-address. The outdated e-address and associated contact information may be retained and reclassified as secondary contact information. In one embodiment, the “modify distribution list” button may provide access to functionality that automatically modifies the existing distribution list by replacing outdated e-addresses with updated recipient e-addresses.

The automatic modification of the e-mail distribution list from the e-addressee fields of an e-mail, either before or after the e-mail is sent, may alleviate the need to manually select each e-address from a lengthy list of e-addresses un-related to the e-mail 200 to modify a distribution list. Manual selection of e-addresses from a separate global or lengthy list of e-mails not related to the e-mail 200 may become tedious or lead to the erroneous selection of an e-address.

After an existing distribution list is modified 116, the title for the distribution list may be automatically created or automatically modified 118. As shown in the example of FIG. 5, the e-mail 200 may include a subject line 216, such as “Wedding,” that is different than the current title of the distribution list “Birthday Party.” In one embodiment, the “modify distribution list” button may provide access to functionality that automatically creates or automatically modifies the name of the distribution list modified.

The software application may automatically name the modified distribution list using all or part of the subject line 216 information. If the subject line 216 is relatively short, the title may include the entire subject line 216, such as “Wedding” or “Surprise Birthday Party.” However, if the subject line 216 is rather long, the title may include a few words automatically selected from the subject line 216, such as the first few words or one or more key words in the subject line 216. Other methods and algorithms may be used to automatically modify the name of a distribution list.

The software application may automatically create or automatically modify contact information associated with the modified distribution list 120. The second drop down menu 222 may include a “modify contact info” button that provides access to functionality that automatically creates or automatically modifies contact information for the modified distribution list. Alternatively, the contact information for the new distribution list may be automatically created via on operation performed on the “modify distribution list” button that also modifies the distribution list.

For a given e-address, the software application may automatically determine the name of an associated individual recipient or a place of business, alternate contact information for the e-mail recipient, such as general or specific work-related contact information, home street address, personal website, secondary e-addresses or other contact information. The software application may add, remove, or replace contact information for the given e-address from the contact information associated with the modified distribution list if that e-address has been added to, removed from, or replaced in the distribution list. For instance, the software application may determine new contact information for a replacement e-address. The software application may replace any outdated contact information associated with an outdated e-address with the new contact information.

IV. Alternate Embodiments

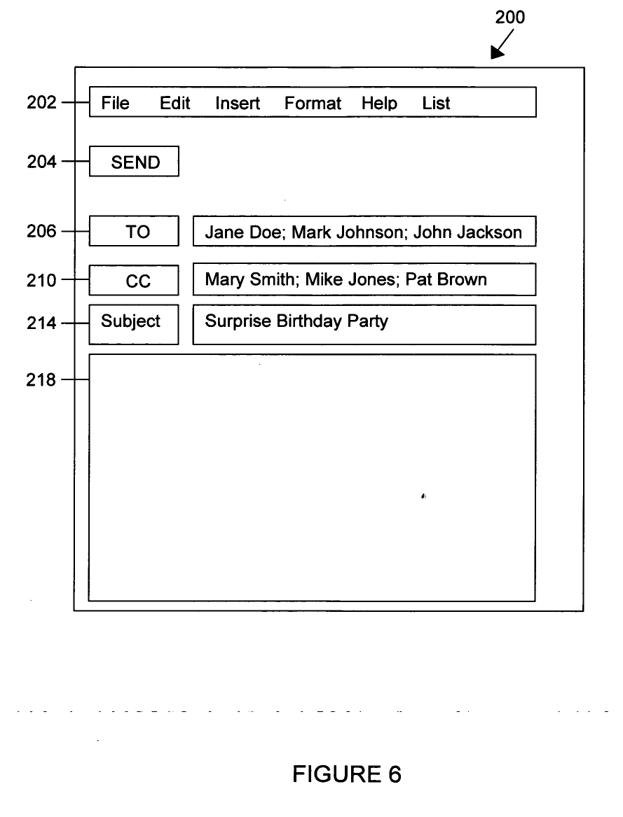

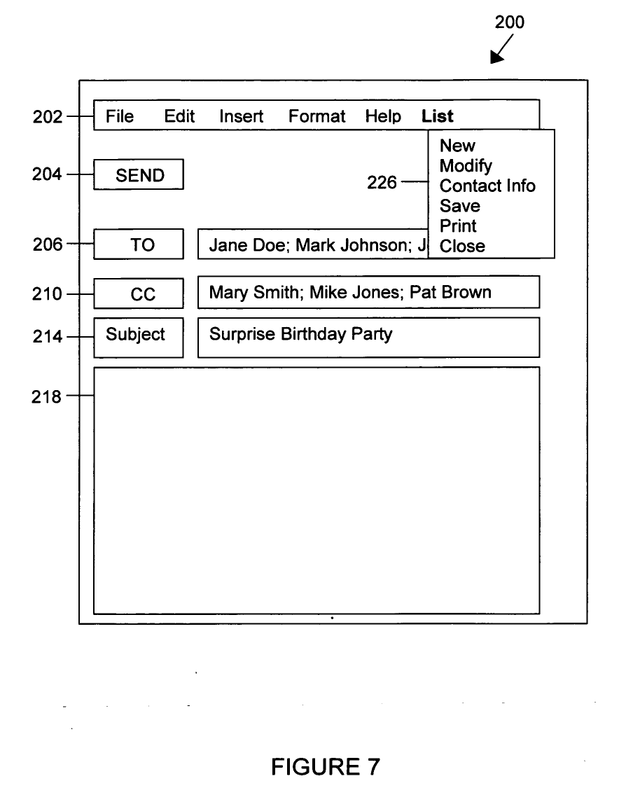

FIGS. 6 and 7 together illustrate an alternate manner of accessing the functionality of the distribution list actions discussed herein. As noted above, the command bar 202 may provide access to a number of e-mail related functions. FIG. 6 illustrates that the command bar 202 may include a distribution list or “list” button that provides access to the distribution list functionality of the software application. The “list” button in the command bar 202 may have an associated drop down menu 226 that may be accessed by moving a cursor over the “list” button, clicking upon the “list” button via an input device, or performing another operation on the “list” button.

As shown in FIG. 7, the drop down menu 226 associated with the “list” button may provide access to distribution list related functionality. In the example shown, the drop down menu 226 may provide a “new” button to automatically create a new distribution list, a “modify” button to automatically modify an existing distribution list, and a “contact info” button to automatically create and/or automatically modify contact information associated with the distribution list. Additional, fewer, or alternate buttons and corresponding functionality may be provided.

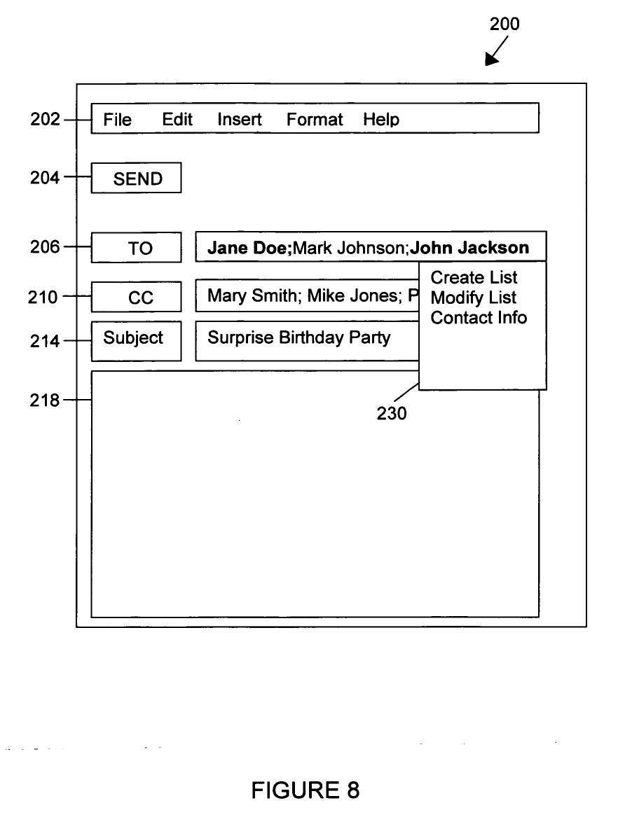

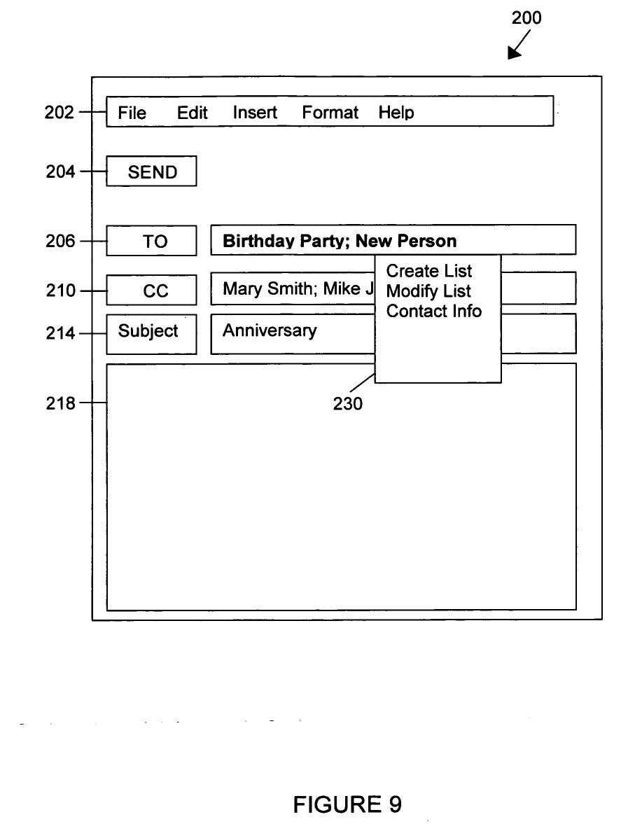

FIGS. 8 and 9 illustrate another alternative manner of accessing the functionality of the distribution list actions discussed herein. As shown in FIG. 8, after the e-addresses of the recipients of an e-mail have been selected, one or more distribution list actions may be accessed via an e-address drop down menu 230 associated with an e-address. The distribution list down menu 230 shown includes a “create list” button, a “modify list” button, and a “contact info” button. The “create list” button may provide access to functionality that creates a new distribution list as discussed herein. The “modify list” button may provide access to functionality that modifies an existing distribution list as discussed herein. The “contact info” button may provide access to functionality that creates and/or modifies contact information associated with a distribution list as discussed herein. The e-address drop down menu may provide additional, fewer, or alternative buttons and corresponding functionality.

A user may highlight or select one or more of the recipient e-addresses upon which a distribution list action is to be performed. The user may highlight or select one or more of the recipient e-addresses via an input device, such as moving a cursor over an e-address, clicking on an e-address, touching the e-address on a touch screen, reading aloud the e-address for a voice recognition input device to recognize, or other actions performed by an input device. The input device may include a keyboard, a mouse, a touch pad, a touch screen, a haptic input device, a joystick, a controller, or other input device.

Alternatively, the distribution list drop down menu 230 may be accessed without individually selecting any of the e-addresses from the e-mail. For instance, the distribution list drop down menu 230 may perform distribution list functions on all of the recipient e-addresses of the e-mail, or all the e-addresses in the “to” field, the “cc” field, both the “to” and “cc” fields, or any other e-addressee field, or combinations thereof.

FIG. 9 illustrates an e-mail 200 includes a distribution list entitled “Birthday Party” as a recipient. A “New Person” also is included as an individual or other list recipient of the e-mail. In such a case, depending upon the subject matter of the e-mail 200, it may be desirable to automatically modify or update the current “Birthday Party” distribution list to include the “New Person” and leave the title of the “Birthday Party” distribution list the same.

Alternatively, the subject matter of the e-mail may be directed to new subject matter, such as an Anniversary as shown in FIG. 9. The software application may automatically create a new distribution list that includes all of the e-addresses of the existing distribution party (“Birthday Party” in this case), as well all of the other recipient e-addresses of the e-mail. Or the software application may automatically create a new distribution list that includes only the additional recipient e-addresses selected, such as the “New Person” e-address highlighted in FIG. 9. In the example shown, the new distribution list may be automatically entitled “Anniversary” or the like using the content of the subject line 216.

V. Exemplary Data Processor

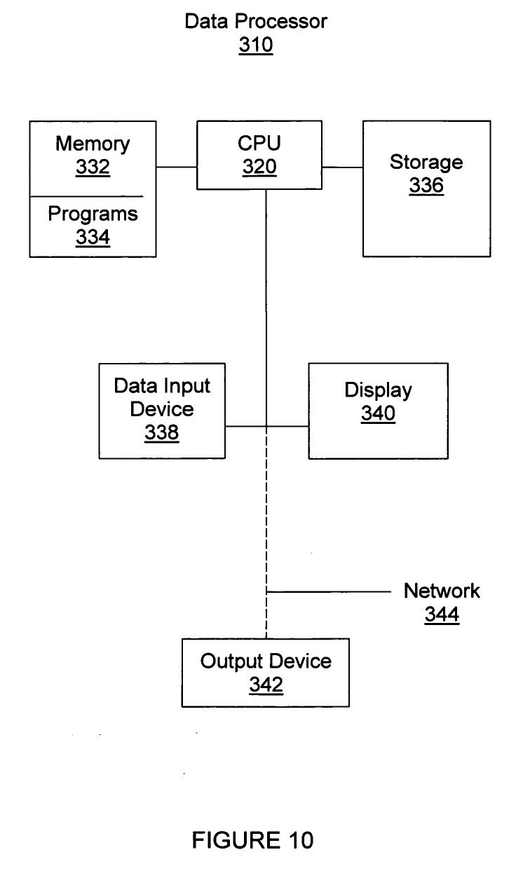

FIG. 10 is a block diagram of an exemplary data processor 310 configured or adapted to provide the functionality for automatically creating and/or modifying an e-mail distribution list. The data processor 310 may include a central processing unit (CPU) 320, a memory 332, a storage device 336, a data input device 338, and a display 340. The data processor 310 also may have an external output device 342, which may be a display, a monitor, a printer or a communications port. The data processor 310 may be a personal computer, work station, server, or other system. The data processor 310 may be interconnected to a network 344, such as an intranet, the Internet, or an intranet connected to the Internet. The data processor 310 may be interconnected to another location via the network 344. The data processor 310 is provided for descriptive purposes and is not intended to limit the scope of the present system. The data processor may have additional, fewer, or alternate components.

A program 334 may reside on the memory 332 and include one or more sequences of executable code or coded instructions that are executed by the CPU 320. The program 334 may be loaded into the memory 332 from the storage device 336. The CPU 320 may execute one or more sequences of instructions of the program 334 to process data. Data may be input to the data processor 310 with the data input device 338 and/or received from the network 344. The program 334 may interface the data input device 338 and/or the network 344 for the input of data. Data processed by the data processor 310 may be provided as an output to the display 340, the external output device 342, the network 344, and/or stored in a database. The program 334 and other data may be stored on or read from machine-readable medium, including secondary storage devices such as hard disks, floppy disks, CD-ROMS, and DVDs; electromagnetic signals; or other forms of machine readable medium, either currently known or later developed.

The program 334 may provide e-mail distribution list functionality as discussed herein. The program 334 may permit a user to draft, send, and receive e-mail such that an e-mail message may be sent or received by the data processor 310 to or from the data input device 338, the network 344, or another input device. After which, the e-mail may be stored in the memory 332, the storage device 336, or other storage unit. The program 334 may direct the data processor 310 to automatically create and/or modify an e-mail distribution list, create and/or modify the title of an e-mail distribution list, and create and/or modify contact information for the associated e-mail distribution list. The distribution lists, titles, and contact information created or modified may be stored in the memory 332, storage 336, or other storage unit. The distribution lists, titles, and contact information created or modified may be transferred to another data processor via the network 344, output device 342, or other manner. The distribution lists, titles, and contact information created or modified may be displayed on the display 340, output device 342, or other display device.

VI. Exemplary Method

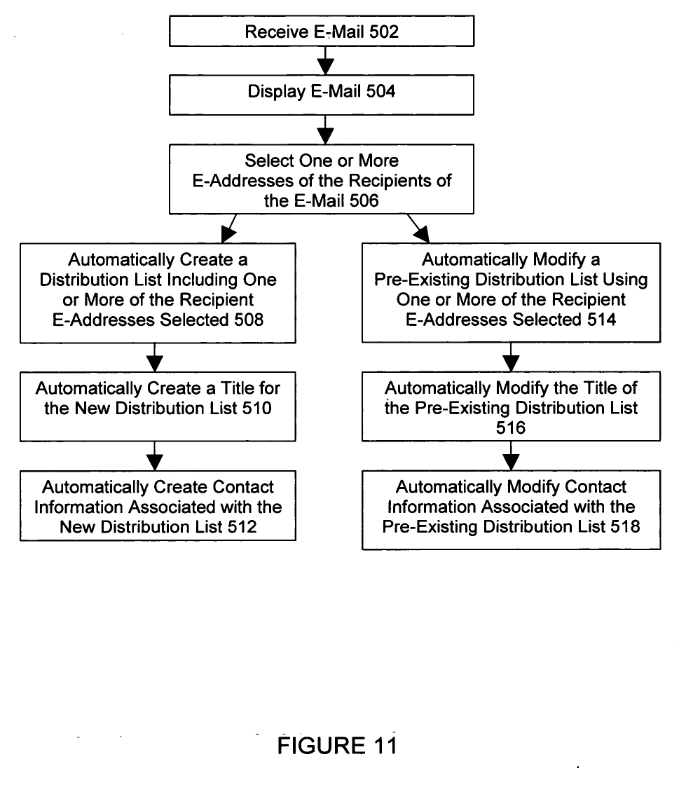

FIG. 11 is a flowchart of another exemplary method for automatically creating and/or automatically modifying an e-mail distribution list. The method may include receiving e-mail 502, displaying the e-mail 504, select one or more e-addresses of the recipients 506, automatically creating an e-mail distribution list 508, automatically creating a title for the new distribution list 510, automatically creating contact information for the new distribution list 512, automatically modifying an existing e-mail distribution list 514, automatically modifying the title of the distribution list 516, and/or automatically modifying the contact information for the distribution list 518. The method may include additional, fewer, or alternate actions.

The method illustrated in FIG. 11 may be substantially performed similar to the method of FIG. 1. For instance the selection of e-addresses 506 and the distribution list actions 508, 510, 512, 514, 516, and 518 may be automatically performed by the software application similarly to the performance of the selection of e-addresses 106 and the distribution list actions 110, 112, 114, 116, 118, and 120 discussed herein with respect to FIG. 1. Other operations may be used.

While the invention has been described above by reference to various embodiments, it should be understood that many changes and modifications can be made without departing from the scope of the invention. The description and illustrations are by way of example only. Many more embodiments and implementations are possible within the scope of this invention and will be apparent to those of ordinary skill in the art. The various embodiments are not limited to the described environments, and have a wide variety of applications including integrated building control systems, environmental control, security detection, communications, industrial control, power distribution, and hazard reporting.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except in light as necessitated by the accompanying claims and their equivalents.

I (We) claim:

1. A data processing system for performing functionality related to an e-mail distribution list, the system comprising:
a display screen operable to display an e-mail, the e-mail having an addressee field including an e-address; and
a processing unit operable to create an e-mail distribution list from the e-address located in the addressee field.

2. The system of claim 1, wherein the e-mail distribution list includes a plurality of e-addresses, the processing unit being operable to automatically create contact information for each of the plurality of e-addresses.

3. The system of claim 1, wherein the processing unit is operable to automatically name the e-mail distribution list.

4. The system of claim 1, wherein the processing unit is operable to automatically modify the e-mail distribution list.

5. The system of claim 4, comprising a user interface operable to select an e-address from the addressee field, wherein the processing unit is operable to automatically add the e-address selected to the e-mail distribution list.

6. The system of claim 4, comprising a user interface operable to select an e-address from the addressee field, wherein the processing unit automatically replaces an outdated e-address in the e-mail distribution list with the e-address selected, the e-address selected being a current e-address of the recipient.

7. The system of claim 4, comprising a user interface operable to select an e-address from the addressee field, wherein the processing unit automatically removes the e-address selected from the e-mail distribution list.

8. The system of claim 1, wherein the processing unit is operable to automatically create the e-mail distribution list.

9. A data processing system for performing functionality related to an e-mail distribution list, the system comprising:
a display screen operable to display an e-mail, the e-mail having an addressee field including an e-address; and
a processing unit operable to modify an e-mail distribution list from the e-address located in the addressee field.

10. The system of claim 9, wherein the processing unit is operable to automatically modify the e-mail distribution list.

11. The system of claim 9, comprising a user interface operable to select the e-address, wherein the e-mail includes the e-mail distribution list to be modified as another addressee located in the addressee field.

12. The system of claim 9, wherein the processing unit is operable to automatically add the e-address to the e-mail distribution list.

13. The system of claim 9, wherein the processing unit is operable to automatically remove the e-address from the e-mail distribution list.

14. The system of claim 9, wherein the processing unit is operable to automatically replace an outdated e-address in the e-mail distribution list with the e-address, the e-address being a current e-address of a recipient.

15. The system of claim 9, wherein the processing unit is operable to automatically modify the title of the e-mail distribution list.

16. The system of claim 9, wherein the processing unit is operable to automatically modify contact information associated with the e-mail distribution list.

17. The system of claim 9, wherein the processing unit is operable to automatically create a new distribution list using a plurality of e-addresses associated with the e-mail.

18. A method for performing functionality related to an e-mail distribution list, the method comprising:
displaying an e-mail on a display screen, the e-mail including an e-address located in an addressee field; and
creating an e-mail distribution list from the e-address located in the addressee field.

19. The method of claim 18, comprising:
automatically creating a title for the e-mail distribution list; and
automatically adding the title of the e-mail distribution list to a list of available e-addresses.

20. The method of claim 18, comprising automatically creating contact information for the e-mail distribution list.

21. The method of claim 18, comprising selecting the e-address from a plurality of e-addresses associated with the e-mail, wherein the e-mail distribution list is created by automatically modifying an existing e-mail distribution list by adding the e-address selected to the existing e-mail distribution list.

22. The method of claim 18, comprising selecting the e-address from a plurality of e-addresses associated with the e-mail, the e-address selected being a current e-address for a recipient, wherein the e-mail distribution list is created by modifying the e-mail distribution list by replacing an outdated e-address in the e-mail distribution list with the current e-address.

23. A computer-readable medium having instructions executable on a computer stored thereon, the instructions comprising:
generating an e-mail having an e-address located within an addressee field; and
creating, modifying, or creating and modifying an e-mail distribution list using the e-address located within the addressee field.

24. The computer-readable medium of claim 23, wherein the address field is a “to” field or a “cc” field.

25. The computer-readable medium of claim 23, comprising automatically creating or automatically modifying a title associated with the e-mail distribution list.

26. The computer-readable medium of claim 23, comprising automatically creating or automatically modifying contact information associated with the e-mail distribution list.
